(19) United States
(12) Patent Application Publication
(10) Pub. No.: US 2005/0203729 A1
(43) Pub. Date: Sep. 15, 2005

(54) Methods and apparatus for replaceable customization of multimodal embedded interfaces

(75) Inventors: Daniel L. Roth, Boston, MA (US); William Barton, Harvard, MA (US); Michael Edgington, Bridgewater, MA (US); Laurence S. Gillick, Newton, MA (US)

Correspondence Address: WILMER CUTLER PICKERING HALE AND DORR LLP, 60 STATE STREET, BOSTON, MA, 02109, US

(73) Assignee: Voice Signal Technologies, Inc., Woburn, MA (US)

(21) Appl. No.: 11/058,407

(22) Filed: Feb. 15, 2005

Related U.S. Application Data
(60) Provisional application No. 60/545,204, filed on Feb. 17, 2004.

(51) Int. Cl. G06F 17/28

(52) U.S. Cl. 704/5

(57) ABSTRACT

According to certain aspects of the invention a mobile voice communication device includes a wireless transceiver circuit for transmitting and receiving auditory information and data, a processor, and a memory storing executable instructions which when executed on the processor causes the mobile voice communication device to provide a selectable personality associated with a user interface to a user of the mobile voice communication device. The executable instructions include implementing on the device a user interface that employs the different user prompts having the selectable personality, wherein each selectable personality of the different user prompts is defined and mapped to data stored in at least one database in the mobile voice communication device. The mobile voice communication device may include a decoder that recognizes a spoken user input and provides a corresponding recognized word, and a speech synthesizer that synthesizes a word corresponding to the recognized word. The device includes user-selectable personalities that are either transmitted wirelessly to the device, transmitted through a computer interface, or provided as memory cards to the device.

### CROSS-REFERENCE TO RELATED APPLICATIONS

This application claims the benefit of U.S. Provisional Patent Application Ser. No. 60/545,204 filed Feb. 17, 2004, the entire contents of which are incorporated herein by reference.

### TECHNICAL FIELD

This invention relates generally to wireless communication devices having speech recognition capabilities.

### BACKGROUND

Many mobile communication devices such as cellular telephones (here meant to encompass at least data processing and devices that carry out telephony or voice communication functions) are provided with voice-assisted interface features that enable a user to access a function by speaking an expression to invoke the function. A familiar example is voice dialing, whereby a user speaks a name or other pre-stored expressions into the telephone and the telephone responds by dialing the number associated with that name. In the alternative, the display and keypad provides a visual interface for the user to type in a text string to which the telephone responds.

To verify that the number to be dialed or the function to be invoked is indeed the one intended by the user, a mobile telephone can display a confirmation message to the user, allowing the user to proceed if correct, or to abort the function if incorrect. Audible and/or visual user interfaces exist for interacting with mobile telephone devices. Audible confirmations and other user interfaces allow a more hands-free operation compared to visual confirmations and interfaces, such as may be needed by a driver wishing to keep his or her eyes on the road instead of looking at a telephone device.

Speech recognition is employed in a mobile telephone to recognize a phrase, word, sound (generally referred to herein as utterances) spoken by the telephone's user. Speech recognition is therefore sometimes used in phonebook applications. In one example, a telephone responds to a recognized spoken name with an audible confirmation, rendered through the telephone's speaker output. The user accepts or rejects the telephone's recognition result on hearing the playback.

One aspect of these interfaces, both audible and visual, is that they have a personality, whether by design or by accident. In the case of an existing commercial device (for example, Samsung i700 device), the internal voice of the cellular telephone has a personality which has been described as “the Lady”. Most current devices are very business-like having short prompts which are to the point and usually lack utterances like “please”, “thank you” or even “like”.

### SUMMARY OF THE INVENTION

According to certain aspects of the invention a mobile voice communication device includes a wireless transceiver circuit for transmitting and receiving auditory information and data, a processor, and a memory storing executable instruction which when executed on the processor causes the mobile voice communication device to provide a selectable personality associated with a user interface to a user of the mobile voice communication device. The executable instructions include implementing on the device a user interface that employs the different user prompts having a selectable personality, wherein each selectable personality of the plurality of user prompts is defined and mapped to data stored in at least one database in the mobile voice communication device. The mobile voice communication device includes a decoder that recognizes a spoken user input and provides a corresponding recognized word, and a speech synthesizer that synthesizes a word corresponding to the recognized word. The decoder includes a speech recognition engine. The mobile communication device is a cellular telephone.

The mobile voice communication device includes at least one database having one of a pronunciation database, a synthesizer database and a user interface database. The pronunciation database includes data representative of letter-to-phoneme rules and/or explicit pronunciations of a plurality of words and phonetic modification rules. The synthesizer database includes data representative of phoneme-to-sound rules, speed controls and/or pitch controls. The user interface database includes data representative of pre-recorded audible prompts, text associated with audible prompts, screen images and animation scripts. The transceiver circuit has an audio input device and an audio output device. The selectable personalities include at least one of a distinctive voice, accent, word choices, grammatical structures and hidden inclusions.

Another aspect of the present invention includes a method for operating a communication device that includes speech recognition capabilities, and includes implementing on the device a user interface that employs a plurality of different user prompts, wherein each user prompt of the different user prompts is for either soliciting a corresponding spoken input from the user or informing the user about an action or state of the device and each user prompt having a selectable personality from a plurality of different personalities. Each personality of the plurality of different personalities is mapped to a corresponding different one of the different user prompts; and when any one of the personalities is selected by the user of the device, the method includes generating the user prompts that are mapped to the selected personality. Each user prompt of the plurality of user prompts has a corresponding language representation and in generating user prompts for the selected personality the corresponding language representation is also generated through the user interface. The method further includes when generating the corresponding language representation through the user interface of the device also audibly presenting the language representation to the user having the selected personality.

The method includes implementing a plurality of user selectable modes having different user prompts, each of the different user prompts having a different personality. The mobile communication device includes a user selectable mode that when chosen randomly selects the personality of the user interfaces, and as such by switching personalities at random can also present multiple personalities to the user, thus, approximating a schizophrenic telephone device. The user selectable personalities can be wirelessly transmitted to the mobile communication device, transmitted through a computer interface or be provided to the mobile communication device as embedded in a memory device.

In general, in another aspect, the invention features a method involving: storing in data storage a plurality of personality data files, each one of which configures a speech-enabled application to mimic a different corresponding personality; receiving an electronic request from a user for a selected one of the personality data files; requesting a payment obligation from the user for the selected personality data file; in response to receiving the payment obligation from the user, electronically transferring the selected personality data file to the user for installation in a device that contains the speech-enabled application.

The foregoing features and advantages of the invention will be apparent from the following more particular description of embodiments of the invention, as illustrated in the accompanying drawings.

### BRIEF DESCRIPTION OF THE DRAWINGS

FIG. 1 is a block diagram of an exemplary cellular telephone illustrating the functional components used for the customization methods described herein.

FIG. 2 is a flow chart showing a process by which “personalities” are downloaded into a cellular telephone.

FIG. 3 is flow chart showing how a user configures a cellular telephone to have a selected “personality.”

FIGS. 4A and 4B are collectively a flow diagram showing an example of a voice dialer flow with a customized personality.

FIGS. 5 and 5B are collectively a flow diagram showing another example of a voice dialer flow having a customized personality of a casual speaking southerner.

FIG. 6 is a block diagram of an exemplary cellular telephone on which the functionality described herein can be implemented.

### DETAILED DESCRIPTION

Mobile voice communication devices such as cellular telephones and other networked computing devices have multimodal interfaces that can be described as having a particular personality. Since these multimodal interfaces are almost exclusively software products, it is possible to impart a personality to the internal processes. These personality profiles are manifested by the user interfaces of the devices and can be a celebrity, for instance, or a politician, a comedian, or a cartoon character. The user interface of the devices include the audible interface which provides audio prompts as well as the visual interface which provides the text strings displayed on the device display. The prompts can be recorded and repeated in a particular voice, for example, “Mickey Mouse,” “John F, Kennedy,” “Mr. T,” etc. Prompts could also be cast with a particular accent, for example, a Boston, an Indian, or southern accent.

A mobile telephone device uses a speech recognizer circuit, a speech synthesis circuit, logic, changes to embedded data structures and pre-recorded prompts, scripts and images to define the personality of the device which in turn provides a particular personality to the multimodal interfaces. The methods and apparatus described herein are directed at providing customization to the multimodal interfaces and thus to the personality manifested by the mobile communication device.

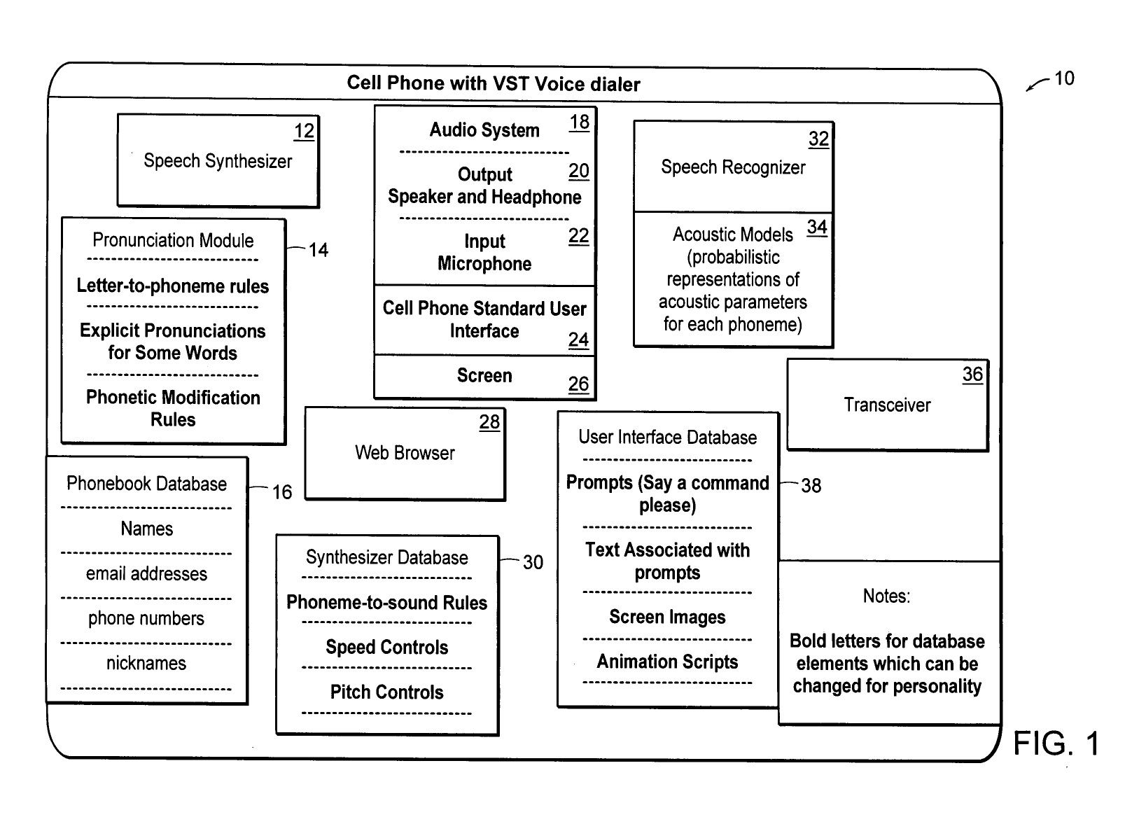

FIG. 1 is a block diagram of an exemplary cellular telephone illustrating the functional components used for the customization methods described herein. The system 10 includes input, output, processing and database components. The cellular telephone uses an audio system 18 that includes an output speaker and/or a headphone 20, and an input microphone 22. The audio input device or microphone 22 receives a user's spoken utterance. The input microphone 22 provides the received audio input signal to the speech recognizer 32. The speech recognizer includes the acoustic models 34 which are probabilistic representations of acoustic parameters for each phoneme. It is the speech recognizer that recognizes the user input (spoken utterance) and provides a recognized word (text) to a pronunciation module 14. In turn the pronunciation module provides an input to the speech synthesizer 12. The recognized word is also provided as a text string to a visual display device.

The pronunciation module 14 builds the acoustic representation of the output signal and provides the representation to the speech recognizer. The pronunciation module 14 includes databases that have stored therein letter-to-phoneme rules and/or explicit pronunciations for particular words and possibly phonetic modifications rules. This data in the different databases of the pronunciation module 14 can be changed to reflect the personality that the user interfaces manifest. For example, the letter-to-phoneme rules for a personality having a Southern accent are different than one for a British accent and the database can be updated to reflect the voice/accent of the personality selected for the phone.

The speech synthesizer 12 synthesizes the audio form of the recognized word using the instructions programmed into the system processor. The synthesizer 12 accesses the phoneme-to-sound rules, speed controls and pitch controls from the synthesizer database 30. The data in the synthesizer database can be changed to represent different personalities that the user interface can be configured to represent.

Further, certain user interface outputs can be pre-recorded and stored in a user interface database 38 for recall by the cellular telephone. This user interface database includes audio prompts, for example, “say a command please”, text-string associated with audio prompts, screen images, such as backgrounds, and animation scripts. The data in the user interface database 38 can be changed to represent the different prompts, screen displays and scripts that are associated with the particular personality selected by a user.

The data in the different databases, for example, the user interface database 38, the synthesizer database 30 and the pronunciation module 14 databases are then used to define the personality of the multimedia interfaces and collectively that of the mobile device.

The personalities associated with the mobile devices can be further personalized by changing the visual prompts. The text associated with the screen prompts can be editable or changeable, as could the actual wording of the prompts.

It is further possible to change the recorded prompts and the prosody of the speech synthesizer to make the mood of the mobile communication device appear, for example, “angry” or “mellow” according to the preferences of the user. Other applications that may have a personality include an MP3 player and a set of carrier commands that are presented to download information.

Since the voice processes in a phone are data driven, a complete personality can be imported to the voice and/or the visual interfaces in the mobile device. The parts of the “personality profile”, that is, the prompts, the models for the synthesizer, and possibly the modification of the text messages in the mobile device, could be packaged into a downloadable object. This object could be made available through a computer interface or wirelessly via standard cell phone channels, or using different wireless protocols, for example, Bluetooth, or infrared protocols or wide band radio (IEEE 802.11 or Wifi). The mobile device could store one or more personalities as an initial configuration in its memory. If the device stores more than one personality, the personality to be used can be selected by the user or by the carrier. In the alternative, the personalities can be stored on replaceable memory cards that can be purchased by the user.

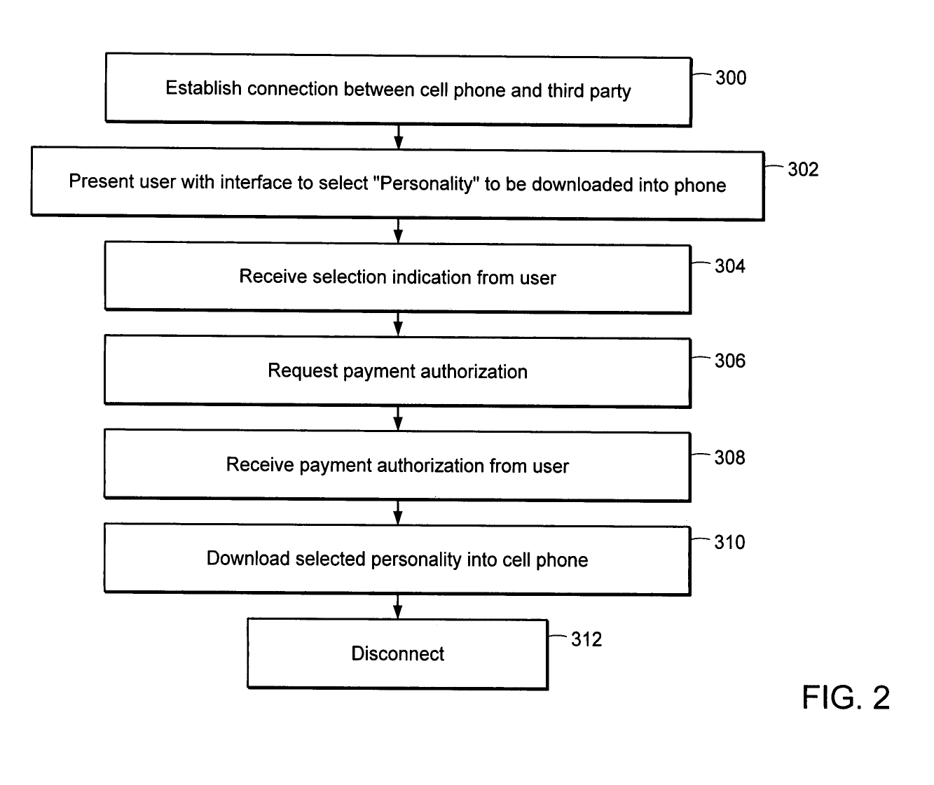

Referring to FIG. 2, according to one embodiment, a user obtains “personalities” by establishing a connection to a third party that provides those “personalities” in downloadable form (step 300), much like ring tones can be downloaded into cellular telephones. This could be done in various ways using know techniques including, for example, through a browser that is available on the cellular phone using the WAP protocol (Wireless Application Protocol) or through any of the other communication protocols mentioned above. Or it can be done through use of an intermediate computer that establishes the communication link with the third party and then transfers the received “personality” files into the cellular telephone.

After the connection is established, the third party displays an interface on the display of the cellular phone that enables the user to select one or more “personalities” among a larger set of available personalities (step 302). After the user selects a personality, this selection is sent to the third party (step 304) which then solicits payment information from the user (step 306). This might be in the form of authorization to charge a credit card that is provided by the user. To complete the transaction, the user provides the requested authorization or payment information. Upon receiving that payment information (step 308), the third party then begins the transfer of the “personality” files into the user's cellular phone over the same communication link (step 310). After the transfer is complete, the connection is terminated (step 312).

One approach is to simply replace one personality in the phone with a downloaded, new alternative personality. In that case, the cellular phone will have a single personality, namely, whatever one was last loaded into the phone. Another approach is to store multiple personalities within the phone and then enable the user through the interface on the phone to select the personality that will be used. This has the advantage of providing a more interesting experience to the user but it also requires more data storage in the phone.

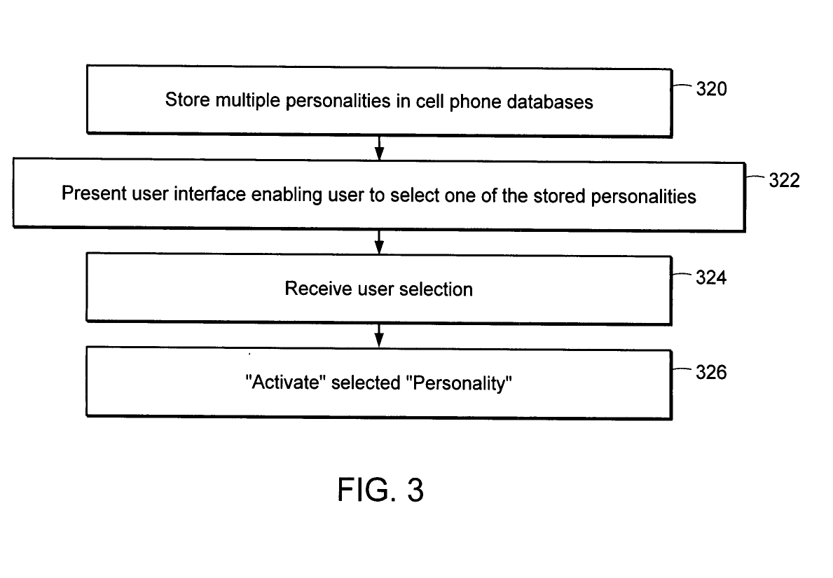

FIG. 3 shows a flow diagram of the operation of a cellular phone that includes multiple personalities. In such a phone, the user, either at the time of purchase or through subsequent downloads, installs into internal memory the data files for each of the multiple personalities (step 320). When the user wants to change the personality of the phone, he simply invokes a user interface that enables him to change the configuration of the phone. In response, the phone displays a menu interface on its LCD that enables the user to select one of the multiple personalities that have been installed in memory (step 322). Upon receiving the selection for the user (step 324), the phone then activates the selected “personality” (step 326).

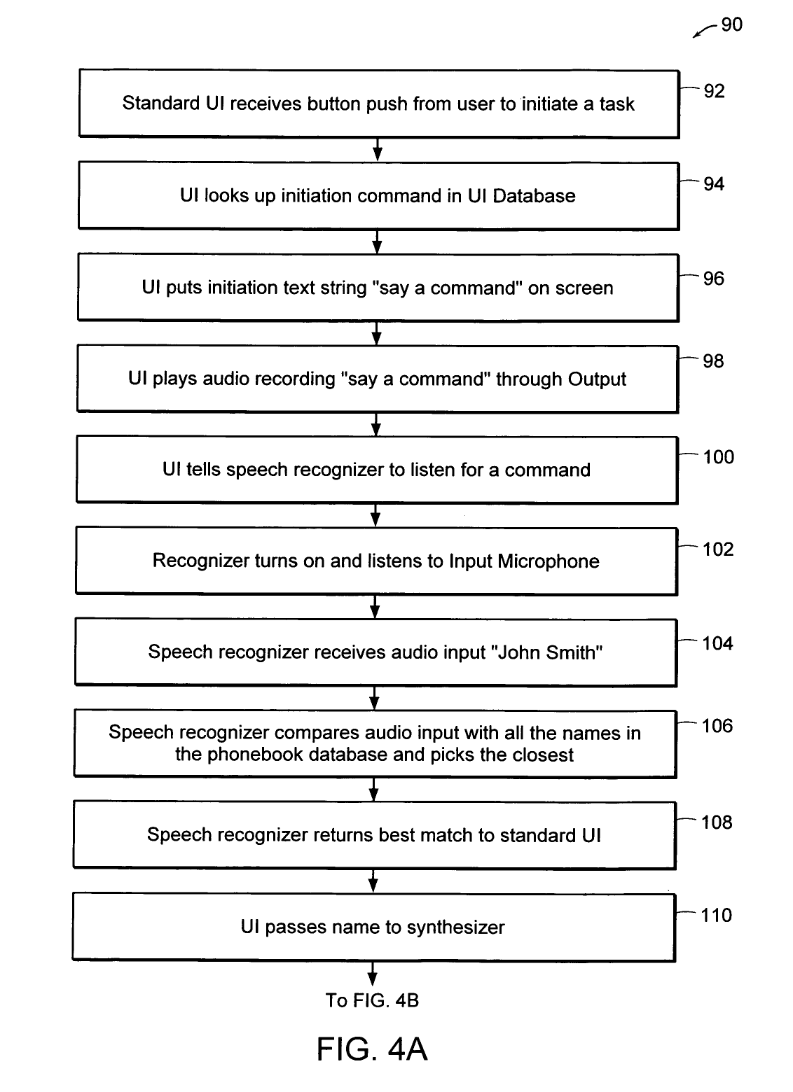

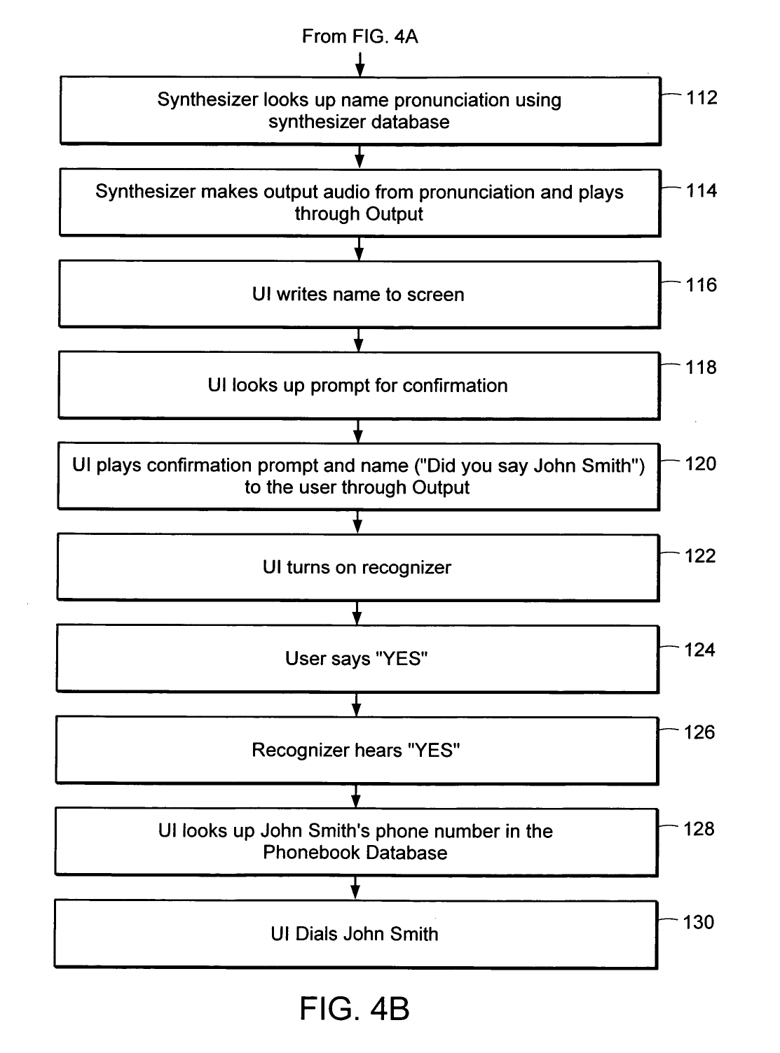

FIGS. 4A and 4B are diagrams showing an example of a voice dialer flow with a customized personality. The standard user interface (UI) receives a prompt, for example, a button push from the user to initiate task in step 92. The UI looks up the initiation command in the UI database in step 94. The UI provides an initiation text string “say a command” on the display screen of the device in step 96. The UI then plays the audio recording “say a command” through an output speaker in step 98. The UI tells the speech recognizer to listen for a command in step 100. The recognizer listens to the input microphone in step 102. The speech recognizer receives audio input “John Smith” in step 104. The speech recognizer then compares the audio input with all the names in the phonebook database and selects the closest one to “John Smith” in step 106. The speech recognizer returns the best match to the standard UI in step 108. The UI passes the name to the synthesizer in step 110. The synthesizer looks up the name pronunciation using the synthesizer database in step 112. The synthesizer generates the output audio from the pronunciation and plays through the output speaker in step 114. The UI writes the name to the screen in step 116. The UI looks up the prompt for confirmation in step 118, and then the UI plays the confirmation prompt and name (“Did you say John Smith?”) to the user through the output speaker in step 120. The UI turns on the recognizer in step 122. The user says “YES” in step 124 followed by the recognizer hearing the word “YES” in step 126. The UI looks up John Smith's phone number in the phonebook database in step 128 and then dials John Smith in step 130 using the phone number.

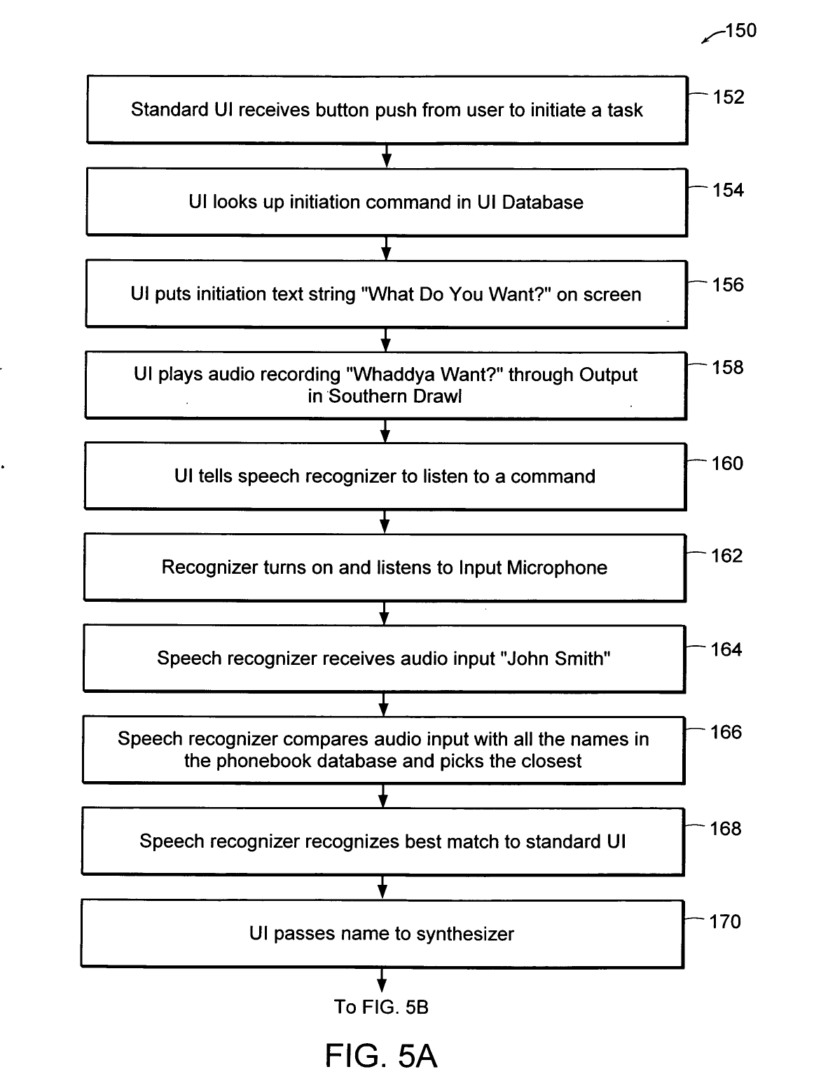

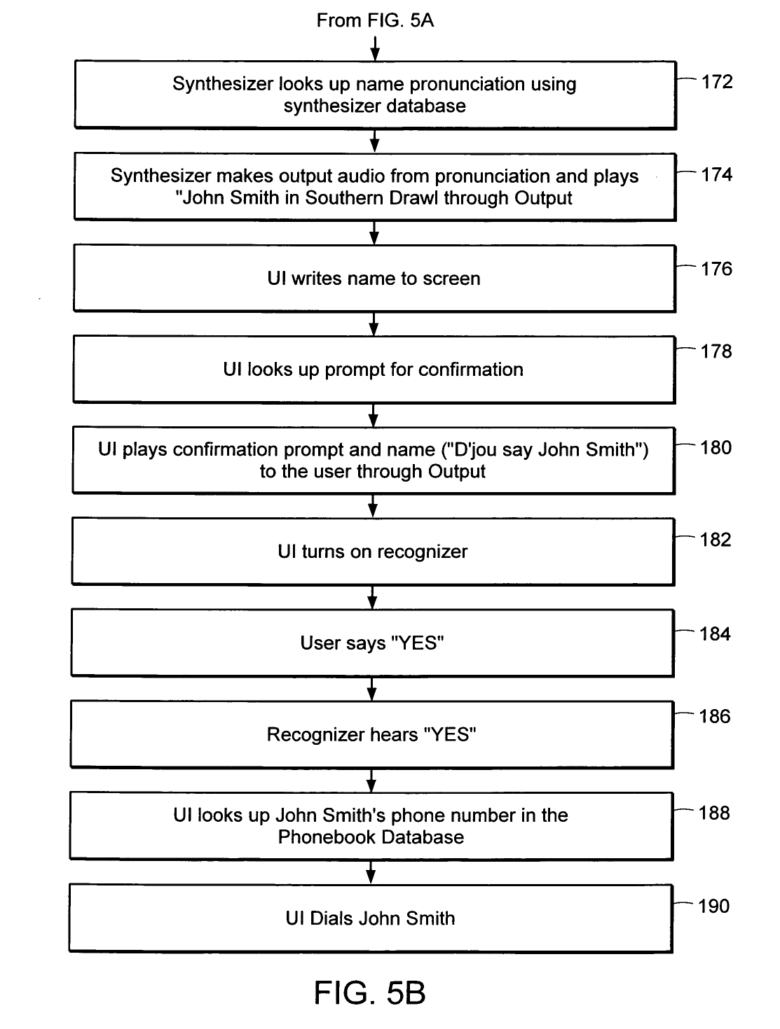

FIGS. 5A and 5B are diagrams showing another example of a voice dialer flow having a customized personality of a casual speaking southerner. The standard UI receives a button push from the user to initiate a task in step 152. The UI looks up the initiation command in the UI database in step 154. The UI provides the initiation text string “What Do You Want?” on the screen display in step 156. The UI plays the audio recording “Whaddaya Want?” through the output speaker in a southern drawl in step 158. The UI tells the speech recognizer to listen for a command in step 160. The recognizer turns on and listens to the input microphone in step 162. The speech recognizer receives an audio input, for example, “John Smith” in step 164. The speech recognizer compares the audio input with all the names in the phonebook database and selects the closest one in step 166. The speech recognizer returns the best match to the standard UI in step 168. The UI then passes the name to the speech synthesizer in step 170. The speech synthesizer looks up the pronunciation of the name using the synthesizer database in step 172. The synthesizer generates the output audio from the pronunciation and plays “John Smith” in a southern drawl through the output speaker in step 174. The UI writes the name to the screen in step 176. The UI looks up the prompt for confirmation in step 178. The UI then plays the confirmation prompt and name “D'jou say John Smith?” to the user though the output speaker in step 182. Similar to the flow diagram described with respect to FIG. 2B, the UI then turns on the recognizer (step 182), the user confirms by saying “Yes” (step 184) and the speech recognizer hears “Yes” (step 186). The UI looks up John Smith's phone number in the phonebook database in step 188 and the UI then dials John Smith in step 190 using the phone number in the phonebook database.

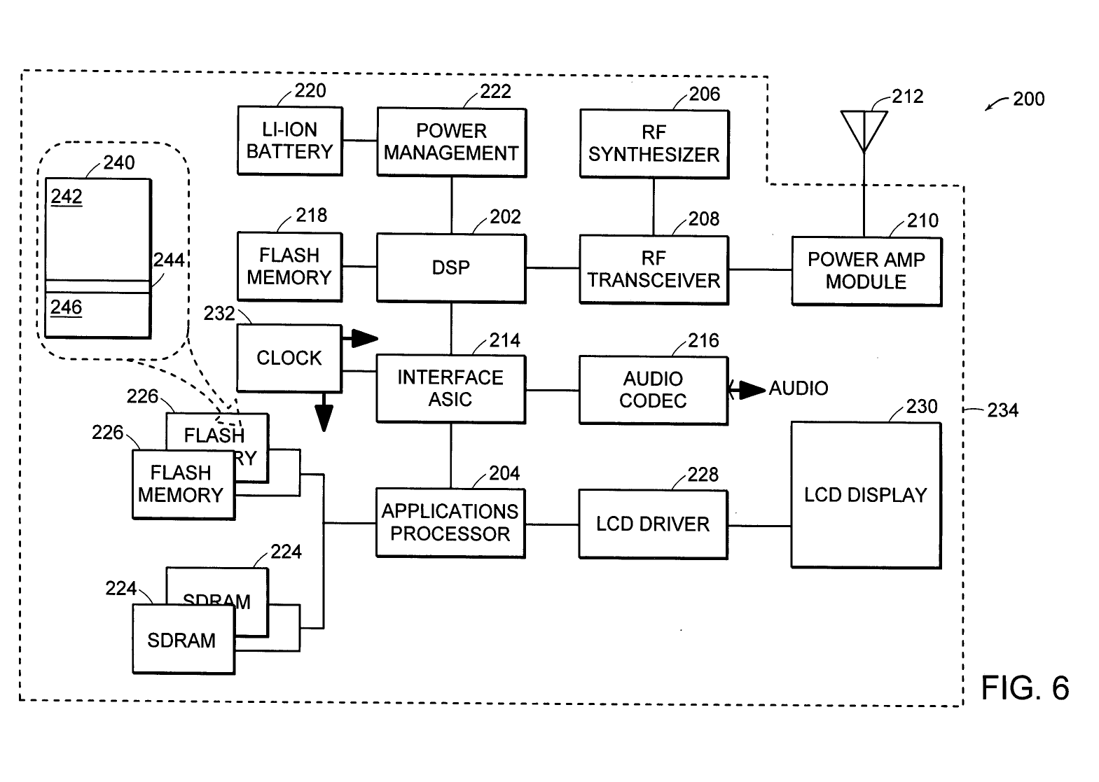

A typical platform on which such functionality can be provided is a smartphone 200, such as is illustrated in the high level block diagram form in FIG. 6. The platform is a cellular phone in which there is embedded application software that includes the relevant functionality to customize the personality of the phone and thus the multimodal interfaces. In this instance, the application software includes, among other programs, voice recognition software that enables the user to access information on the phone (for example, telephone numbers of identified persons) and to control the cell phone through verbal commands. The voice recognition software also includes enhanced functionality in the form of a speech-to-text function that enables the user to enter text into an email message through spoken words.

In the described embodiment, smartphone 200 is a Microsoft PocketPC-powered phone which includes at its core a baseband DSP 202 (digital signal processor) for handling the cellular communication functions including, for example, voiceband and channel coding functions and an applications processor 204 (for example, Intel StrongArm SA-1110) on which the PocketPC operating system runs. The phone supports GSM voice calls, SMS (Short Messaging Service) text messaging, wireless email (electronic mail), and desktop-like web browsing along with more traditional PDA features.

The transmit and receive functions are implemented by an RF synthesizer 206 and an RF radio transceiver 208 followed by a power amplifier module 210 that handles the final-stage RF transmit duties through an antenna 212. An interface ASIC 214 (application specific integrated circuit) and an audio CODEC 216 (coder/decoder) provide interfaces to a speaker, a microphone, and other input/output devices provided in the phone such as a numeric or alphanumeric keypad (not shown) for entering commands and information.

The DSP 202 uses a flash memory 218 for code store. A Li-Ion (lithium-ion) battery 220 powers the phone and a power management module 222 coupled to DSP 202 manages power consumption within the phone. Volatile and non-volatile memory for applications processor 214 is provided in the form of SDRAM 224 (synchronized dynamic random access memory) and flash memory 226, respectively. This arrangement of memory is used to hold the code for the operating system, the code for customizable features such as the phone directory, and the code for any applications software that might be included in the smartphone, including the voice recognition software mentioned hereinafter. The visual display device for the smartphone includes an LCD (liquid crystal display) driver chip 228 that drives an LCD display 230. There is also a clock module 232 that provides the clock signals for the other devices within the phone and provides an indicator of real time.

All of the above-described components are packages within an appropriately designed housing 234.

Since the smartphone described herein is representative of the general internal structure of a number of different commercially available smartphones and since the internal circuit design of those phones is generally known to persons of ordinary skill in this art, further details about the components shown in FIG. 6 and their operation are not being provided and are not necessary to understanding the invention.

The internal memory of the phone includes all relevant code for operating the phone and for supporting its various functionality, including code 240 for the voice recognition application software, which is represented in block form in FIG. 6. The voice recognition application includes code 242 for its basic functionality as well as code 244 for enhanced functionality, which in this case is speech-to-text functionality 244. The code or sequence of executable instructions for replaceable customization in multimodal embedded interfaces as described herein are stored in the internal memory of the communication device and as such can be implemented on any phone or device having an application processor.

In view of the wide variety of embodiments to which the principles of the invention can be applied, it should be understood that the illustrated embodiments are exemplary only, and should not be taken as limiting the scope of the invention. For example, the steps of the flow diagrams (FIGS. 4A, 4B, 5A and 5B) may be taken in sequences other than those described, and more or fewer elements may be used in the diagrams. The user interface flow can be altered by adding a teaching mode to the device. In the user-selectable teaching mode, the device interfaces with the user in each step to apprise the user as to what function the device is performing and instructs the user as to what the user should do next. While various elements of the embodiments have been described as being implemented in software, other embodiments in hardware or firmware implementations may alternatively be used, and vice-versa.

It will be apparent to those of ordinary skill in the art that methods involved in the replaceable customization in multimodal embedded interfaces may be embodied in a computer program product that includes a computer usable medium. For example, such a computer usable medium can include a readable memory device, such as, a hard drive device, a CD-ROM, a DVD-ROM, or a computer diskette, having computer readable program code segments stored thereon. The computer readable medium can also include a communications or transmission medium, such as, a bus or a communications link, either optical, wired, or wireless having program code segments carried thereon as digital or analog data signals.

Other aspects, modifications, and embodiments are within the scope of the following claims.

1. A mobile voice communication device comprising:
a wireless transceiver circuit for transmitting and receiving auditory information and data;
a processor; and
a memory storing executable instructions which when executed on the processor causes the mobile voice communication device to provide a selectable personality associated with the device to a user of the mobile voice communication device, said executable instructions including implementing on the device a user interface that employs a plurality of different user prompts having at least one selectable personality, wherein each selectable personality of the plurality of user prompts is defined and mapped to data stored in at least one database in the mobile voice communication device.

2. The mobile voice communication device of claim 1, further comprising:
a decoder that recognizes a spoken user input and provides a corresponding recognized word; and
a speech synthesizer that synthesizes a word corresponding to the recognized word.

3. The mobile voice communication device of claim 2, wherein the decoder comprises a speech recognition engine.

4. The mobile voice communication device of claim 1, wherein the device is a mobile telephone device.

5. The mobile voice communication device of claim 1, wherein the at least one database comprises one of a pronunciation database, a synthesizer database and a user interface database.

6. The mobile voice communication device of claim 5, wherein the pronunciation database comprises data representative of at least one of letter-to-phoneme rules, explicit pronunciations of a plurality of words and phonetic modification rules.

7. The mobile voice communication device of claim 5, wherein the synthesizer database comprises data representative of at least one of phoneme-to-sound rules, speed controls and pitch controls.

8. The mobile voice communication device of claim 5, wherein the user interface database comprises data representative of at least one of pre-recorded audible prompts, text associated with audible prompts, screen images and animation scripts

9. The mobile voice communication device of claim 1, wherein the transceiver circuit includes an audio input device and an audio output device.

10. The mobile voice communication device of claim 1, wherein each of the selectable personalities comprises at least one of a distinctive voice, accent, word choices, grammatical structures and hidden inclusions.

11. A method for operating a communication device that includes speech recognition capabilities, the method comprising:
implementing on the device a user interface that employs a plurality of different user prompts, wherein each user prompt of said plurality of different user prompts is for either soliciting a corresponding spoken input from the user or informing the user about an action or state of the device and each user prompt of said plurality of different user prompts having at least one of selectable personality from a plurality of different personalities; each personality of said plurality of different personalities being mapped to a corresponding different one of said plurality of user prompts; and
when any one of said plurality of personalities is selected by the user of the device, generating the user prompts that are mapped to the selected personality.

12. The method of claim 11, wherein each user prompt of the plurality of user prompts has a corresponding language representation and wherein generating user prompts for the selected personality further comprises generating the corresponding language representation through the user interface.

13. The method of claim 12, wherein generating the corresponding language representation through the user interface further comprises visually displaying said language representation to the user.

14. The method of claim 12, wherein generating the corresponding language representation through the user interface further comprises audibly presenting said language representation to the user having the selected personality.

15. The method of claim 11, wherein each of the plurality of different personalities comprise at least one of a distinctive voice, accent, word choices, and grammatical structures.

16. The method of claim 11, further comprising:
implementing a plurality of user selectable modes having different user prompts, each of the different user prompts having a different personality.

17. The method of claim 11, wherein each of the different user-selectable personalities is one of wirelessly transmitted to the mobile communication device, transmitted through a computer interface or is provided to the mobile communication device as embedded in a memory device.

18. The method of claim 11, further comprising implementing a user selectable mode for randomly generating at least one of a plurality of different personalities.

19. A method comprising:
storing in data storage a plurality of personality data files, each one of which configures a speech-enabled application to mimic a different corresponding personality;
receiving an electronic request from a user for a selected one of the personality data files;
requesting a payment obligation from the user for the selected personality data file; and
in response to receiving the payment obligation from the user, electronically transferring the selected personality data file to the user for installation in a device that contains the speech-enabled application.
